(19) United States
(12) Patent Application Publication
(10) Pub. No.: US 2015/0261937 A1
(43) Pub. Date: Sep. 17, 2015

(54) EVALUATION METHOD FOR CHARACTERISTICS OF MIXTURE, USING COMBINATION OF PURE SUBSTANCES, AND SYSTEM USING SAME

(71) Applicant: LG CHEM. LTD., Seoul (KR)

(72) Inventors: Seungyup Lee, Daejeon (KR); Hyesung Cho, Daejeon (KR)

(21) Appl. No.: 14/433,349

(22) PCT Filed: Jul. 15, 2014
(86) PCT No.: PCT/KR2014/006372

§ 371 Date: Apr. 2, 2015

(30) Foreign Application Priority Data
Jul. 31, 2013 (KR) 10-2013-0090987

(51) Int. Cl. G06F 19/00; G01N 30/86

(52) U.S. Cl. CPC G06F 19/70; G01N 30/8679

(57) ABSTRACT

The present invention relates to an evaluation method for characteristics of a mixture, using a combination of pure substances, and a system using the same and, more specifically, to: an evaluation method for characteristics of a mixture, using a combination of pure substances, the evaluation method using identification of the unique characteristics of a mixture by the reduced number of pure substances (IDMixRPS), which is a calculation method capable of representing characteristics of a mixture by using a combination of pure substances, as a new approach for evaluating the characteristics of the mixture; and a system using the same.

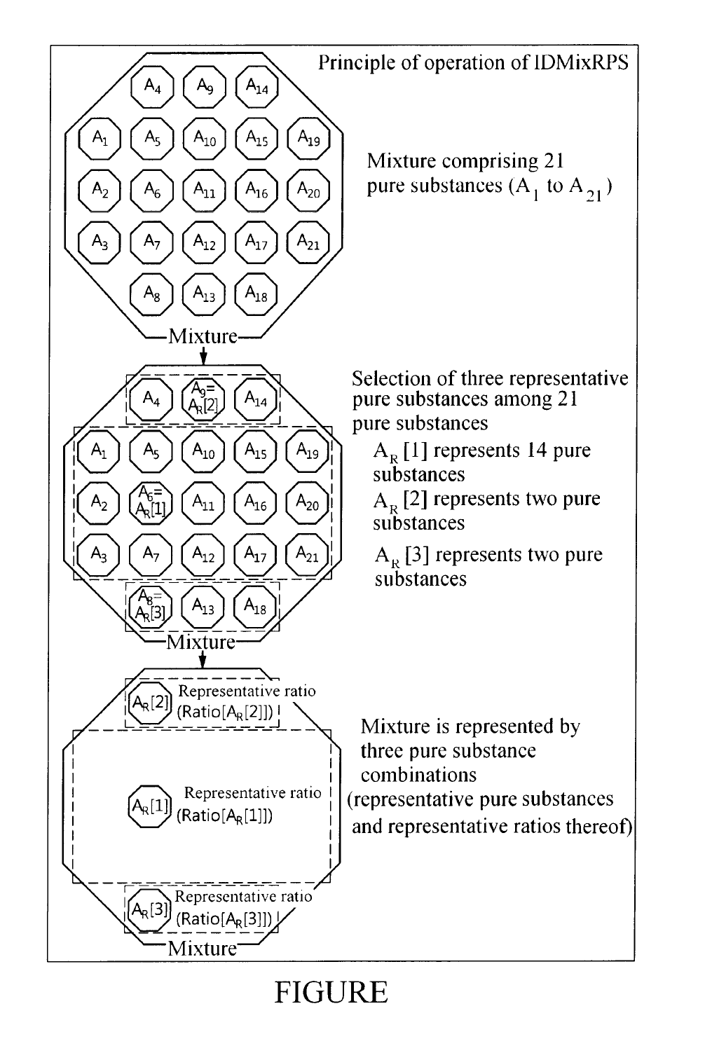

### TECHNICAL FIELD

The present invention relates to an evaluation method for characteristics of a mixture, using a combination of pure substances, and a system using the same and, more specifically, to: an evaluation method for characteristics of a mixture, using a combination of pure substances, the evaluation method using identification of the unique characteristics of a mixture by the reduced number of pure substances (IDMixRPS), which is a calculation method capable of representing characteristics of a mixture by using a combination of pure substances, as a new approach for evaluating the characteristics of the mixture; and a system using the same.

### BACKGROUND ART

A mixture refers to two or more pure substances that are mixed with each other without formation of chemical bonding, wherein the unique properties of individual pure substances in the mixture are maintained. Thus, physicochemical characteristics of the mixture are determined by complex actions depending on the kind, number and composition of pure substances of the mixture, and are thus very difficult to evaluate, unlike the pure substances. Effective use of a mixture essentially requires a method of evaluating characteristics of the mixture.

The present invention is directed to IDMixRPS as a method of evaluating characteristics of a mixture by searching for a combination of representative pure substances that have a great influence on such characteristics based on the results of evaluation of characteristics of all the pure substances of the mixture. In order to search for a combination of representative pure substances, it is essential to evaluate unique properties of individual pure substances.

To determine solubility or miscibility of substances, similarity of the substances should be compared using unique properties thereof. Among a variety of unique properties that affect solubility or miscibility, particularly useful is a solubility parameter for quantifying the extent of interaction of substances. Specifically, individual substances have unique solubility parameters, and substances having similar solubility parameters are dissolved in or are miscible with each other.

Among solubility parameters proposed and utilized based on various theories or concepts, the Hansen solubility parameter (HSP) devised by Dr. C. Hansen, 1967, is known to evaluate solubility characteristics very accurately. As for HSP, the extent of interaction of substances is considered by the following three elements:

(1) δD is a nonpolar solubility parameter due to dispersion interactions;

(2) δP is a polar solubility parameter due to permanent dipole-permanent dipole interactions; and

(3) δH is a hydrogen bond solubility parameter.

Thus, HSP is widely utilized to evaluate more accurately and systematically solubility or miscibility of the substances because it provides specific interaction information of the substances, compared to the other solubility parameters.

HSP=(δD,δP,δH),(J/cm³)^{1/2} (1)

δTot=(δD²+δP²+δH²)^{1/2},(J/cm³)^{1/2} (2)

HSP is regarded as a vector having a magnitude and direction in a space made up of three elements, and δTot shows the magnitude of HSP vector. A basic unit of the HSP is (J/cm³)^{1/2}. Such HSP values are calculated using a program referred to as HSPiP (Hansen Solubility Parameters in Practice) by a research group led by Dr. Hansen, who developed HSP.

When two substances have similar HSP values, they dissolve well in each other. In order to determine that substances are similar, three HSP elements and the HSP magnitude of individual substances should be similar because HSP is a vector. All the pure substances have unique HSPs, and pure substances having similar HSPs exhibit similar physicochemical characteristics. Hence, to compare characteristics of the pure substances, HSP similarity has to be evaluated.

Specifically, HSP similarity may be determined by an HSP difference (HSP-Diff), which may be calculated using Equation 1 below.

HSP-Diff(A,B)=(α|×|δD(A)−δD(B)|^{β}+α2×|δP(A)−δP(B)|^{β}+α3×|δH(A)−δH(B)|^{β})^{γ} [Equation 1]

In Equation 1, A and B show pure substances of a mixture; α₁, α₂, and α₃ are real numbers greater than zero and are not particularly limited, but α₁ is a real number of 0.5˜4.5, α₂ is a real number of 0.5˜3, and α₃ is a real number of 0.5˜2.5; β is a real number greater than zero and is not particularly limited, but is a real number of 1.0˜2.5; and γ is a real number excluding zero and is not particularly limited, but is a real number of −2.5˜−0.1 or 0.1˜2.5.

Equation 1 is used to calculate HSP-Diff(A,B) corresponding to an HSP difference between different pure substances A and B. As the HSP difference between pure substances A and B increases, HSP-Diff(A,B) has a great value. When A and B are the same pure substance, HSP-Diff(A,B) equals 0.0. The present inventors have searched for N_{RP} (N_{RP}>0) representative pure substances able to represent characteristics of the pure substances among N pure substances of the mixture using IDMixRPS based on the HSP similarity, and also representative ratios thereof, in order to evaluate characteristics of the mixture. Accordingly, IDMixRPS enables characteristics of a mixture, which was difficult to evaluate conventionally, to be systematically evaluated by virtue of a pure substance combination, and thereby is considered to give important information on a mixture in the future.

### DISCLOSURE

### Technical Problem

The present invention has been made keeping in mind the above problems in the related art, and an object of the present invention is to provide a novel method of searching for representative pure substances able to represent characteristics of a mixture among pure substances of the mixture and for representative ratios of the representative pure substances.

### Technical Solution

In order to accomplish the above object, the present invention provides a method of evaluating characteristics of a mixture using a pure substance combination, comprising:

a) measuring the kind of pure substances (Aₘ) of a mixture and a composition ratio (R[Aₘ]) thereof;

b) evaluating characteristic similarity of pure substances of the mixture; and

c) determining one or more representative pure substances for representing characteristics of the mixture among pure substances of the mixture and representative ratios thereof.

In addition, the present invention provides a system for evaluating characteristics of a mixture using a pure substance combination, comprising:

a data input module for receiving data for the kind of pure substances (Aₘ) of a mixture and a composition ratio (R[Aₘ]) thereof;

an evaluation module for receiving data for characteristic similarity of pure substances of the mixture; and

a determination module for receiving data for one or more representative pure substances for representing characteristics of the mixture among pure substances of the mixture and representative ratios thereof.

### Advantageous Effects

According to the present invention, a method of evaluating characteristics of a mixture using a pure substance combination, namely, IDMixRPS is applied, and thereby representative pure substances and representative ratios thereof can be selected so as to represent physicochemical characteristics of the mixture, which were difficult to evaluate conventionally. Furthermore, characteristics of the mixture can be evaluated via a simple combination of representative pure substances. Therefore, the present invention is expected to be very useful in terms of more systematically using and evaluating the mixture.

### DESCRIPTION OF DRAWING

The FIGURE is a schematic view illustrating a principle of operation of IDMixRPS according to the present invention.

### BEST MODE

Hereinafter, a detailed description will be given of the present invention.

According to the present invention, a method of evaluating characteristics of a mixture using a pure substance combination comprises:

a) measuring the kind of pure substances (Aₘ) of a mixture and a composition ratio (R[Aₘ]) thereof;

b) evaluating characteristic similarity of pure substances of the mixture; and

c) determining one or more representative pure substances for representing characteristics of the mixture among pure substances of the mixture and representative ratios thereof

By the present inventors, a method of evaluating characteristics of a mixture using a pure substance combination is referred to as “IDMixRPS (Identification of the unique characteristics of a Mixture by the Reduced number of Pure Substances)”.

In a), the kind of pure substances (Aₘ) of the mixture and the composition ratio (R[Aₘ]) thereof are measured.

The composition ratio may be a molar ratio or a weight ratio. Either a molar ratio or a weight ratio may be used in the present invention, depending on the needs.

The kind and composition ratio of pure substances of the mixture may be quantitatively measured using gas chromatography (GC), liquid chromatography (LC), or high performance liquid chromatography (HPLC).

In b), characteristic similarity of the pure substances of the mixture is evaluated.

More specifically, evaluating the characteristic similarity of the pure substances of the mixture in b) may be executed by calculating HSP-Diff values between N pure substances Aₘ and the other pure substances using Equation 1 below, and calculating an arithmetic average (Avg_HSP[Aₘ]) of the HSP-Diff values using Equation 2 below.

$$\begin{matrix}HSP - Diff ( {A}_{m} , {A}_{i} ) = {( α1 \times {\vert δ D ( {A}_{m} ) - δ D ( {A}_{i} ) \vert}^{β} + α2 \times {\vert δ P ( {A}_{m} ) - δ P ( {A}_{i} ) \vert}^{β} + α3 \times {\vert δ H ( {A}_{m} ) - δ H ( {A}_{i} ) \vert}^{β} )}^{r} & [ Equation 1 ] \\ Avg\_HSP \{ {A}_{m} ] = \frac{1}{N} {\sum }_{i = 1}^{N} HSP - Diff ( {A}_{m} , {A}_{i} ) & [ Equation 2 ]\end{matrix}$$

In Equation 1, HSP shows HSP=(δD, δP, δH), wherein δD is a nonpolar solubility parameter due to dispersion interactions, δP is a polar solubility parameter due to permanent dipole-permanent dipole interactions, and δH is a hydrogen bond solubility parameter; α₁, α₂, and α₃ are real numbers greater than zero and are not particularly limited, but α₁ is a real number of 0.5˜4.5, α₂ is a real number of 0.5˜3, and α₃ is a real number of 0.5β2.5; β is a real number greater than zero and is not particularly limited, but is a real number of 1.0˜2.5; and γ is a real number excluding zero and is not particularly limited, but is a real number of −2.5˜−0.1 or 0.1˜2.5. In Equation 2, Aₘ indicates N pure substances (m=a natural number of 1 to N).

In c), determining one or more representative pure substances for representing characteristics of the mixture and representative ratios thereof is executed by:

1) designating a minimum value of the arithmetic average (Avg_HSP[Aₘ]) of N HSP-Diff values determined in b) to MIN[k], and designating Aₘ that shows the minimum value to a k^{th} representative pure substance A_{R}[k] (k=1);

2) designating the pure substances Aₘ satisfying HSP-Diff(A_{R}[k],Aₘ)<σ[k] for the representative pure substance A_{R}[k] to members of SET{A_{R}[k],L[k]} (wherein L[k] is 1 to N_{R}[k], N_{R}[k] shows the total number of pure substances Aₘ as the members of SET{A_{R}[k],L[k]} for the representative pure substance A_{R}[k], and σ[k] is a real number of 1.0˜8.5);

3) calculating a sum (Ratio[A_{R}[k]]) of the composition ratio (R[A_{R}[k]]) of A_{R}[k] and the composition ratio (R[Aₘ]) of the pure substances Aₘ as the members of SET{A_{R}[k],L[k]} to determine a representative ratio;

4) designating a minimum value of the arithmetic average (Avg_HSP[Aₘ]) of HSP-Diff values of remaining pure substances other than the pure substances designated as the members of SET{A_{R}[k],L[k]} to MIN[k+1], and designating Aₘ that shows the minimum value to a k+1^{th} representative pure substance A_{R}[k+1]; and

5) repeating 2) to 4) until no pure substance remains, thereby determining the representative pure substances and the representative ratios thereof.

More specifically, determining one or more representative pure substances for representing characteristics of the mixture and representative ratios thereof in c) may be carried out by the following 1) to 8).

As such, the composition ratio R[Aₘ] of each pure substance Aₘ is designated, and a sum of R[Aₘ] of N pure substances of the mixture equals 1.0.

$${\sum }_{m = 1}^{N} R [ {A}_{m} ] = 1.0 \qquad [ Equation 6 ]$$

In 1), a minimum value of the arithmetic average (Avg_HSP[Aₘ]) of N HSP-Diff values is designated to MIN[k], and Aₘ that shows the minimum value is designated to a k^{th} representative pure substance A_{R}[k], wherein k is 1.

In 2), N−1 pure substances Aₘ other than the representative pure substance A_{R}[k] designated in 1) are designated to FF[Aₘ]=‘NONE’. The procedure in 2) is implemented as follows.

DO m=1, N

IF Aₘ is not A_{R}[k]
THEN

FF[Aₘ]=‘NONE’

ELSE

FF[Aₘ]=‘AR[k]’

ENDIF

ENDDO

In 3), the pure substances Aₘ satisfying both FF[Am]=‘NONE’ and HSP-Diff(A_{R}[k],Aₘ)<σ[k] for the representative pure substance A_{R}[k] are designated as the members of SET{A_{R}[k],L[k]}, wherein L[k] is a natural number of 1 to N_{R}[k], N_{R}[k] is the total number of pure substances Aₘ as the members of SET{A_{R}[k],L[k]} for the k^{th} representative pure substance A_{R}[k], and σ[k] is a real number of 1.0˜8.5.

The procedure in 3) is implemented as follows.

L[k]=0
DO m=1, N

IFFF[Aₘ]=‘NONE’ && HSP-Diff(A_{R}[k], Aₘ) < σ[k]
THEN

L[k]=L[k]+1
SET[A_{R}[k], L[k]] = Aₘ
FF[Aₘ]=‘A_{R}[k]’

ENDIF

ENDDO

N_{R}[k]=L[k]

In 4), a sum (Ratio[A_{R}[k]]) of the composition ratio (R[A_{R}[k]]) of A_{R}[k] and the composition ratio (R[Aₘ]) of the pure substances Aₘ as the members of SET{A_{R}[k],L[k]} is calculated and shows the total ratio represented by the representative pure substance A_{R}[k].

In 5), a total number (N_{T}) of pure substances Aₘ as members of SET{A_{R}[k],L[k]} for N_{RP} representative pure substances A_{R}[k] is calculated using Equation 3 below. As such, N_{T} indicates the total number of pure substances related to the representative pure substance, namely, the total number of pure substances able to represent characteristics of the representative pure substance.

$${N}_{T} = {\sum }_{k = 1}^{{N}_{RP}} {N}_{R} [ k ] \qquad [ Equation 3 ]$$

In 6), RR corresponding to the ratio of the number of pure substances reduced by the N_{RP} representative pure substances A_{R}[k] relative to the total number of pure substances of the mixture is calculated using Equation 4 below. As such, RR is a real number of 0.0˜1.0. When the representative pure substances represent all the pure substances of the mixture, RR equals 1.0, and when there is no representative pure substance, RR equals 0.0.

$$RR = \frac{{N}_{T} + {N}_{RP}}{N} \qquad [ Equation 4 ]$$

In 7), a sum (TOT-R) of representative ratios of the N_{RP} representative pure substances A_{R}[k] is calculated using Equation 5 below. As such, TOT-R is a real number of 0.0 to 1.0. When the representative pure substances represent all the pure substances of the mixture, TOT-R equals 1.0, and when there is no representative pure substance, TOT-R shows 0.0.

$$TOT \text{-} R = {\sum }_{k = 1}^{{N}_{RP}} Ratio [ {A}_{R} [ k ] ] \qquad [ Equation 5 ]$$

In 8), when the RR and TOT-R values satisfy RR≧0.65˜0.90 or TOT-R≧0.70˜0.95 (convergence criteria), the representative pure substances exhibit characteristics of the mixture and thus a representative pure substance selection process is terminated, whereas when the RR and TOT-R values do not satisfy RR≧0.65˜0.90 or TOT-R≧0.70˜0.95, a minimum value of the arithmetic average (Avg_HSP[Aₘ]) of HSP-Diff values for remaining pure substances other than the pure substances designated as the members of SET{A_{R}[k],L[k]} is designated to MIN[k+1], and Aₘ that shows the minimum value is designated to a k+1^{th} representative pure substance A_{R}[k+1]. Thereby, characteristics of the mixture comprising N pure substances are identified by N_{RP} representative pure substances (A_{R}[k]) and representative ratios (Ratio[A_{R}[k]]) thereof

Also, when 3) to 8) are repeated 500˜1000 times until the convergence criteria of RR and TOT-R are satisfied, the representative pure substance selection process is terminated upon determining that no pure substance remains, or when the convergence criteria of RR and TOT-R are not satisfied after repeating 3) to 8) 500˜1000 times, the representative pure substance selection process is terminated upon determining that no representative pure substance can be selected.

Through the above steps, characteristics of the mixture comprising N pure substances may be evaluated by the N_{RP} representative pure substances (A_{R}[k]) and the representative ratios (Ratio[A_{R}[k]]) thereof

The FIGURE schematically illustrates the principle of operation of IDMixRPS according to the present invention. When a mixture comprises 21 different pure substances, three representative pure substances A_{R}[k] are selected from among 21 pure substances through the steps as above. As such, the representative pure substance A_{R}[1] is related to the other 14 pure substances and represents them, and each of A_{R}[2] and A_{R}[3] is related to the other two pure substances and represents them. Therefore, IDMixRPS enables the mixture comprising 21 pure substances to be evaluated via three pure substance combinations (representative pure substances and representative ratios thereof).

In addition, the present invention addresses a system for evaluating characteristics of a mixture using a pure substance combination, by the evaluation method as above.

The system for evaluating characteristics of a mixture using a pure substance combination comprises:

a data input module for receiving data for the kind of pure substances (Aₘ) of a mixture and a composition ratio (R[Aₘ]) thereof;

an evaluation module for receiving data for characteristic similarity of pure substances of the mixture; and

a determination module for receiving data for one or more representative pure substances for representing characteristics of the mixture among pure substances of the mixture and representative ratios thereof.

The kind and composition ratio of pure substances of the mixture input to the data input module may be quantitatively measured using gas chromatography (GC), liquid chromatography (LC), or high performance liquid chromatography (HPLC).

Also, the composition ratio input to the data input module may be a molar ratio or a weight ratio.

Also, evaluating the characteristic similarity of the pure substances of the mixture using the evaluation module may be implemented by calculating HSP-Diff values between N pure substances Aₘ and the other pure substances using Equation 1 below, and calculating an arithmetic average (Avg_HSP[Aₘ]) of the HSP-Diff values using Equation 2 below.

$$\begin{matrix}HSP \text{-} Diff ( {A}_{m} , {A}_{i} ) = {( α 1 \times {\vert δ D ( {A}_{m} ) - δ D ( {A}_{i} ) \vert}^{β} + α 2 \times {\vert δ P ( {A}_{m} ) - δ P ( {A}_{i} ) \vert}^{β} + α 3 \times {\vert δ H ( {A}_{m} ) - δ H ( {A}_{i} ) \vert}^{β} )}^{r} & [ Equation 1 ] \\ Avg\_HSP [ {A}_{m} ] = \frac{1}{N} {\sum }_{i = 1}^{N} HSP \text{-} Diff ( {A}_{m} , {A}_{i} ) & [ Equation 2 ]\end{matrix}$$

In Equation 1, HSP shows HSP=(δD, δP, δH), wherein δD is a nonpolar solubility parameter due to dispersion interactions, δP is a polar solubility parameter due to permanent dipole-permanent dipole interactions, and δY1 is a hydrogen bond solubility parameter; α₁, α₂, and α₃ are real numbers greater than zero and are not particularly limited, but α₁ is a real number of 0.5˜4.5, α₂ is a real number of 0.5˜3, and α₃ is a real number of 0.5˜2.5; β is a real number greater than zero and is not particularly limited, but is a real number of 1.0˜2.5; and γ is a real number excluding zero and is not particularly limited, but is a real number of −2.5˜−0.1 or 0.1˜2.5. In Equation 2, Aₘ indicates N pure substances (m=a natural number of 1 to N).

Also, determining one or more representative pure substances for representing characteristics of the mixture and representative ratios thereof using the determination module may be implemented by:

1) designating a minimum value of the arithmetic average (Avg_HSP[Aₘ]) of N HSP-Diff values determined using the evaluation module to MIN[k], and designating Aₘ that shows the minimum value to a k^{th} representative pure substance A_{R}[k] (k=1);

2) designating pure substances Aₘ satisfying HSP-Diff(A_{R}[k],Aₘ)<σ[k] for the representative pure substance A_{R}[k] to members of SET{A_{R}[k],L[k]} (wherein L[k] is 1 to N_{R}[k], N_{R}[k] shows the total number of pure substances Aₘ as the members of SET{AR[k],L[k]} for the representative pure substance A_{R}[k], and σ[k] is a real number of 1.0˜8.5);

3) calculating a sum (Ratio[A_{R}[k]]) of the composition ratio (R[A_{R}[k]]) of A_{R}[k] and the composition ratio (R[Aₘ]) of the pure substances Aₘ as the members of SET{A_{R}[k],L[k]} to determine a representative ratio;

4) designating a minimum value of the arithmetic average (Avg_HSP[Aₘ]) of HSP-Diff values of remaining pure substances other than the pure substances designated as the members of SET{A_{R}[k],L[k]} to MIN[k+1], and designating Aₘ that shows the minimum value to a k+1^{th} representative pure substance A_{R}[k+1]; and

5) repeating 2) to 4) until no pure substance remains, thus determining the representative pure substances and the representative ratios thereof.

Specifically, determining one or more representative pure substances for representing characteristics of the mixture and representative ratios thereof using the determination module may be executed by:

1) designating a minimum value of the arithmetic average (Avg_HSP[Aₘ]) of N HSP-Diff values to MIN[k], and designating Aₘ, that shows the minimum value to a k^{th} representative pure substance A_{R}[k] (k=1);

2) designating N−1 pure substances Aₘ other than the representative pure substance A_{R}[k] designated in 1) to FF[Aₘ]=‘NONE’;

3) designating the pure substances Aₘ satisfying both FF[Am]=‘NONE’ and HSP-Diff(A_{R}[k],Aₘ)<σ[k] for the representative pure substance A_{R}[k] to members of SET{A_{R}[k],L[k]} (wherein L[k] is a natural number of 1 to N_{R}[k], N_{R}[k] is the total number of pure substances Aₘ as the members of SET{A_{R}[k],L[k]} for the k^{th} representative pure substance A_{R}[k], and σ[k] is a real number of 1.0˜8.5);

4) calculating a sum (Ratio[A_{R}[k]]) of the composition ratio (R[A_{R}[k]]) of A_{R}[k] and the composition ratio (R[Aₘ]) of the pure substances Aₘ as the members of SET {A_{R}[k],L[k] };

5) calculating a total number (N_{T}) of pure substances Aₘ as members of SET{A_{R}[k],L[k]} for N_{RP} representative pure substances A_{R}[k] using Equation 3 below:

$${N}_{T} = {\sum }_{k = 1}^{{N}_{RP}} {N}_{R} [ k ] ; \qquad [ Equation 3 ]$$

6) calculating RR corresponding to the ratio of the number of pure substances reduced by the N_{RP} representative pure substances A_{R}[k] relative to the total number of pure substances of the mixture using Equation 4 below (wherein RR is a real number of 0.0˜1.0):

$$RR = \frac{{N}_{T} + {N}_{RP}}{N} ; \qquad [ Equation 4 ]$$

7) calculating a sum (TOT-R) of representative ratios of the N_{RP} representative pure substances A_{R}[k] using Equation 5 below (wherein TOT-R is a real number of 0.0˜1.0):

$$TOT \text{-} R = {\sum }_{k = 1}^{{N}_{RP}} Ratio [ {A}_{R} [ k ] ] ; \qquad [ Equation 5 ]$$

8) terminating a representative pure substance selection process when the RR and TOT-R values satisfy RR≧0.65˜0.90 or TOT-R≧0.70˜0.95 (convergence criteria) in which the representative pure substances exhibit characteristics of the mixture, whereas when the RR and TOT-R values do not satisfy RR≧0.65˜0.90 or TOT-R≧0.70˜0.95 (convergence criteria), designating a minimum value of the arithmetic average (Avg_HSP[Aₘ]) of HSP-Diff values of remaining pure substances other than the pure substances designated as the members of SET{A_{R}[k],L[k]} to MIN[k+1], and designating Aₘ that shows the minimum value to a k+1^{th} representative pure substance A_{R}[k+1]. The determination module enables characteristics of the mixture comprising N pure substances to be identified by N_{RP} representative pure substances (A_{R}[k]) and representative ratios (Ratio[A_{R}[k]]) thereof.

Also, when 3) to 8) are repeated 500˜1000 times until the convergence criteria of RR and TOT-R are satisfied, the representative pure substance selection process is terminated upon determining that no pure substance remains, or when the convergence criteria of RR and TOT-R are not satisfied after repeating 3) to 8) 500˜1000 times, the representative pure substance selection process is terminated upon determining that no representative pure substance can be selected.

As used herein, the term “module” refers to one unit for processing a specific function or operation, and may be embodied by hardware, software, or a combination of hardware and software.

### MODE FOR INVENTION

A better understanding of the present invention may be obtained via the following examples that are set forth to illustrate, but are not to be construed as limiting the scope of the present invention. The scope of the present invention is described in the claims, and includes all modifications within ranges and meanings equivalent to the claims.

### Example

In order to select pure substance combinations for representing characteristics of a mixture to evaluate such characteristics, IDMixRPS was applied for the mixture comprising pure substances and weight ratios of the pure substances as shown in Table 1 below. HSP values between pure substances were compared using HSP-Diff of Equation 1 below and Avg_HSP of Equation 2 below.

$$\begin{matrix}HSP \text{-} Diff ( {A}_{m} , {A}_{i} ) = {( α 1 \times {\vert δ D ( {A}_{m} ) - δ D ( {A}_{i} ) \vert}^{β} + α 2 \times {\vert δ P ( {A}_{m} ) - δ P ( {A}_{i} ) \vert}^{β} + α 3 \times {\vert δ H ( {A}_{m} ) - δ H ( {A}_{i} ) \vert}^{β} )}^{r} & [ Equation 1 ] \\ Avg\_HSP [ {A}_{m} ] = \frac{1}{N} {\sum }_{i = 1}^{N} HSP \text{-} Diff ( {A}_{m} , {A}_{i} ) & [ Equation 2 ]\end{matrix}$$

In Equations 1 and 2, A, and Aₘ indicate pure substances of the mixture. In this example, α₁, α₂, and α₃ were set to 0.8, 1.0, and 1.0, respectively, β was set to 2.0, and γ was set to 0.5. σ[k] was set to 1.5+(k−1)×0.5. RR≧0.8 was set to the convergence criterion.

TABLE 1

| No. | Pure Substance | Weight ratio | Composition ratio |
|---|---|---|---|
| 1 | 1-Chloro-2-Ethoxy Benzene | 2 | 0.2 |
| 2 | Benzophenone | 1 | 0.1 |
| 3 | Benzoyl Chloride | 2 | 0.2 |
| 4 | Methyl Oleate | 3 | 0.3 |
| 5 | Ethyl Amyl Ketone | 1 | 0.1 |
| 6 | Trioctyl Phosphate | 1 | 0.1 |

Based on the results of calculation of Avg_HSP for six pure substances, benzoyl chloride had the smallest value of 2.1 (MIN(1)). Briefly, the first representative pure substance A_{R}[1] was benzoyl chloride. The pure substances related to benzoyl chloride were 1-chloro-2-ethoxybenzene and benzophenone having HSP-Diff smaller than σ[1] (=1.5). Since RR for one A_{R}[1] and two related pure substances was 0.5, it did not satisfy the convergence criterion (RR≧0.8). In addition, methyl oleate, ethyl amyl ketone and trioctyl phosphate, which were pure substances other than the foregoing, were calculated for Avg_HSP. Based on such calculation results, ethyl amyl ketone exhibited the smallest value of 0.7 (MIN(2)), and was selected as the second representative pure substance A_{R} [2]. The pure substances related to ethyl amyl ketone were methyl oleate and trioctyl phosphate having values smaller than σ[2] (=2.0). As such, RR calculated for two representative pure substances and related pure substances was 1.0, and thus satisfied the convergence criterion (RR≧0.8). The representative ratios Ratio[A_{R}[1]] and Ratio[A_{R}[2]] of the representative pure substances were 0.5 and 0.5, respectively. Accordingly, characteristics of the mixture comprising six pure substances can be identified by two (N_{RP}) representative pure substances, namely, benzoyl chloride and ethyl amyl ketone, and individual representative ratios 0.5 and 0.5 thereof.

1. A method of evaluating characteristics of a mixture using a pure substance combination, comprising:
a) measuring a kind of pure substances (Aₘ) of a mixture and a composition ratio (R[Aₘ]) thereof;
b) evaluating characteristic similarity of the pure substances of the mixture; and
c) determining one or more representative pure substances for representing characteristics of the mixture among the pure substances of the mixture and representative ratios thereof.

2. The method of claim 1, wherein measuring the kind of pure substances of the mixture and the composition ratio thereof in a) is performed via quantitative measurement using gas chromatography (GC), liquid chromatography (LC), or high performance liquid chromatography (HPLC).

3. The method of claim 1, wherein the composition ratio in a) is a molar ratio or a weight ratio.

4. The method of claim 1, wherein evaluating characteristic similarity of the pure substances of the mixture in b) is performed by calculating Hansen solubility parameter difference (HSP-Diff) values between N pure substances Aₘ and the other pure substances using Equation 1 below, and calculating an arithmetic average (Avg_HSP[Aₘ]) of the HSP-Diff values using Equation 2 below:
$$\begin{matrix}HSP \text{-} Diff ( {A}_{m} , {A}_{i} ) = {( α 1 \times {\vert δ D ( {A}_{m} ) - δ D ( {A}_{i} ) \vert}^{β} + α 2 \times {\vert δ P ( {A}_{m} ) - δ P ( {A}_{i} ) \vert}^{β} + α 3 \times {\vert δ H ( {A}_{m} ) - δ H ( {A}_{i} ) \vert}^{β} )}^{r} & [ Equation 1 ] \\ Avg\_HSP [ {A}_{m} ] = \frac{1}{N} {\sum }_{i = 1}^{N} HSP \text{-} Diff ( {A}_{m} , {A}_{i} ) & [ Equation 2 ]\end{matrix}$$
wherein HSP shows HSP=(δD, δP, δH), wherein δD is a nonpolar solubility parameter due to dispersion interactions, δP is a polar solubility parameter due to permanent dipole-permanent dipole interactions, and δH is a hydrogen bond solubility parameter; α1, α2, and α3 are real numbers greater than zero; β is a real number greater than zero; γ is a real number excluding zero; and Am indicates N pure substances (m=a natural number of 1 to N), and Ai indicates the other pure substances.

5. The method of claim 4, wherein α₁ is a real number of 0.5˜4.5, α₂ is a real number of 0.5˜3, α₃ is a real number of 0.5˜2.5, β is a real number of 1.0˜2.5, and γ is a real number of −2.5˜−0.1 or 0.1˜2.5.

6. The method of claim 4, wherein determining one or more representative pure substances for representing characteristics of the mixture and representative ratios thereof in c) is performed by:
1) designating a minimum value of the arithmetic average (Avg_HSP[Aₘ]) of N HSP-Diff values determined in b) to MIN[k], and designating Aₘ that shows the minimum value to a k^{th} representative pure substance A_{R}[k] (k=1);
2) designating pure substances Aₘ satisfying HSP-Diff(A_{R}[k],Aₘ)<σ[k] for the representative pure substance A_{R}[k] to members of SET{A_{R}[k],L[k]}(wherein L[k] is 1 to N_{R}[k], N_{R}[k] shows a total number of pure substances Aₘ as the members of SET{A_{R}[k],L[k]} for the representative pure substance A_{R}[k], and σ[k] is a real number of 1.0˜8.5);
3) calculating a sum (Ratio[A_{R}[k]]) of a composition ratio (R[A_{R}[k]]) of A_{R}[k] and a composition ratio (R[Aₘ]) of the pure substances Aₘ as the members of SET {A_{R}[k],L[k]} to determine a representative ratio;
4) designating a minimum value of the arithmetic average (Avg_HSP[Aₘ]) of HSP-Diff values of remaining pure substances other than the pure substances designated as the members of SET{A_{R}[k],L[k]} to MIN[k+1], and designating Aₘ that shows the minimum value to a k+1^{th} representative pure substance A_{R}[k+1]; and
5) repeating 2) to 4) until no pure substance remains, thus determining the representative pure substances and the representative ratios thereof.

7. The method of claim 6, wherein determining one or more representative pure substances for representing characteristics of the mixture and representative ratios thereof in c) is performed by:
1) designating a minimum value of the arithmetic average (Avg_HSP[Aₘ]) of N HSP-Diff values to MIN[k], and designating Aₘ that shows the minimum value to a k^{th} representative pure substance A_{R}[k] (k=1);
2) designating N−1 pure substances Aₘ other than the representative pure substance A_{R}[k] designated in 1) to FF[Aₘ]=‘NONE’;
3) designating pure substances Aₘ satisfying both FF[Am]=‘NONE’ and HSP-Diff(A_{R}[k],Aₘ)<σ[k] for the representative pure substance A_{R}[k] to members of SET{A_{R}[k],L[k]} (wherein L[k] is a natural number of 1 to N_{R}[k], N_{R}[k] is a total number of pure substances Aₘ as the members of SET{A_{R}[k],L[k]} for the k^{th} representative pure substance A_{R}[k], and σ[k] is a real number of 1.0˜8.5);
4) calculating a sum (Ratio[A_{R}[k]]) of a composition ratio (R[A_{R}[k]]) of A_{R}[k] and a composition ratio (R[Aₘ]) of the pure substances Aₘ as the members of SET {A_{R}[k],L[k] };
5) calculating a total number (N_{T}) of pure substances Aₘ as members of SET{A_{R}[k],L[k]} for N_{RP} representative pure substances A_{R}[k] using Equation 3 below:
$${N}_{T} = {\sum }_{k = 1}^{{N}_{RP}} {N}_{R} [ k ] ; \qquad [ Equation 3 ]$$
6) calculating RR corresponding to a ratio of a number of pure substances reduced by the N_{RP} representative pure substances A_{R}[k] relative to a total number of pure substances of the mixture using Equation 4 below (wherein RR is a real number of 0.0˜1.0):
$$RR = \frac{{N}_{T} + {N}_{RP}}{N} ; \qquad [ Equation 4 ]$$
7) calculating a sum (TOT-R) of representative ratios of the N_{RP} representative pure substances A_{R}[k] using Equation 5 below (wherein TOT-R is a real number of 0.0˜1.0):
$$TOT \text{-} R = {\sum }_{k = 1}^{{N}_{RP}} Ratio [ {A}_{R} [ k ] ] ; \qquad [ Equation 5 ]$$
and
8) terminating a representative pure substance selection process when the RR and TOT-R values satisfy RR≧0.65˜0.90 or TOT-R≧0.70˜0.95 (convergence criteria) in which the representative pure substances exhibit characteristics of the mixture, whereas when the RR and TOT-R values do not satisfy RR≧0.65˜0.90 or TOT-R≧0.70˜0.95 (convergence criteria), designating a minimum value of the arithmetic average (Avg_HSP[Aₘ]) of HSP-Diff values for remaining pure substances other than the pure substances designated as the members of SET{A_{R}[k],L[k]} to MIN[k+1], and designating Aₘ that shows the minimum value to a k+1^{th} representative pure substance A_{R}[k+1], thus identifying characteristics of the mixture comprising N pure substances by the N_{RP} representative pure substances (A_{R}[k]) and the representative ratios (Ratio[A_{R}[k]]) thereof.

8. The method of claim 7, wherein when 3) to 8) are repeated 500˜1000 times until the convergence criteria of RR and TOT-R are satisfied, the representative pure substance selection process is terminated upon determining that no pure substance remains, or when the convergence criteria of RR and TOT-R are not satisfied after repeating 3) to 8) 500˜1000 times, the representative pure substance selection process is terminated upon determining that no representative pure substance can be selected.

9. A system for evaluating characteristics of a mixture using a pure substance combination, comprising:
a data input module for receiving data for a kind of pure substances (Aₘ) of a mixture and a composition ratio (R[Aₘ]) thereof;
an evaluation module for receiving data for characteristic similarity of pure substances of the mixture; and
a determination module for receiving data for one or more representative pure substances for representing characteristics of the mixture among pure substances of the mixture and representative ratios thereof.

10. The system of claim 9, wherein measuring the kind of pure substances of the mixture and the composition ratio thereof using the data input module is performed via quantitative measurement using gas chromatography (GC), liquid chromatography (LC), or high performance liquid chromatography (HPLC).

11. The system of claim 9, wherein the composition ratio of the data input module is a molar ratio or a weight ratio.

12. The system of claim 9, wherein evaluating characteristic similarity of pure substances of the mixture using the evaluation module is performed by calculating HSP-Diff values between N pure substances Aₘ and the other pure substances using Equation 1 below, and calculating an arithmetic average (Avg_HSP[Aₘ]) of the HSP-Diff values using Equation 2 below:
$$\begin{matrix}HSP \text{-} Diff ( {A}_{m} , {A}_{i} ) = {( α 1 \times {\vert δ D ( {A}_{m} ) - δ D ( {A}_{i} ) \vert}^{β} + α 2 \times {\vert δ P ( {A}_{m} ) - δ P ( {A}_{i} ) \vert}^{β} + α 3 \times {\vert δ H ( {A}_{m} ) - δ H ( {A}_{i} ) \vert}^{β} )}^{r} & [ Equation 1 ] \\ Avg\_HSP [ {A}_{m} ] = \frac{1}{N} {\sum }_{i = 1}^{N} HSP \text{-} Diff ( {A}_{m} , {A}_{i} ) & [ Equation 2 ]\end{matrix}$$
wherein HSP shows HSP=(δD, δP, δH), wherein δD is a nonpolar solubility parameter due to dispersion interactions, δP is a polar solubility parameter due to permanent dipole-permanent dipole interactions, and δH is a hydrogen bond solubility parameter; α₁, α₂, and α₃ are real numbers greater than zero; β is a real number greater than zero; γ is a real number excluding zero; and Aₘ indicates N pure substances (m=a natural number of 1 to N), and Aᵢ indicates the other pure substances.

13. The system of claim 12, wherein α₁ is a real number of 0.5˜4.5, α₂ is a real number of 0.5˜3, α₃ is a real number of 0.5˜2.5, β is a real number of 1.0˜2.5, and γ is a real number of −2.5˜−0.1 or 0.1˜2.5.

14. The system of claim 12, wherein determining one or more representative pure substances for representing characteristics of the mixture and representative ratios thereof using the determination module is performed by:
1) designating a minimum value of the arithmetic average (Avg_HSP[Aₘ]) of N HSP-Diff values determined using the evaluation module to MIN[k], and designating Aₘ that shows the minimum value to a k^{th} representative pure substance A_{R}[k] (k=1);
2) designating pure substances Aₘ satisfying HSP-Diff(A_{R}[k],Aₘ)<σ[k] for the representative pure substance A_{R}[k] to members of SET{A_{R}[k],L[k]} (wherein L[k] is 1 to N_{R}[k], N_{R}[k] shows a total number of pure substances Aₘ as the members of SET{AR[k],L[k]} for the representative pure substance A_{R}[k], and σ[k] is a real number of 1.0˜8.5);
3) calculating a sum (Ratio[A_{R}[k]]) of a composition ratio (R[A_{R}[k]]) of A_{R}[k] and a composition ratio (R[Aₘ]) of the pure substances Aₘ as the members of SET {A_{R}[k],L[k]} to determine a representative ratio;
4) designating a minimum value of the arithmetic average (Avg_HSP[Aₘ]) of HSP-Diff values of remaining pure substances other than the pure substances designated as the members of SET{A_{R}[k],L[k]} to MIN[k+1], and designating Aₘ that shows the minimum value to a k+1^{th} representative pure substance A_{R}[k+1]; and
5) repeating 2) to 4) until no pure substance remains, thus determining the representative pure substances and the representative ratios thereof.

15. The system of claim 14, wherein determining one or more representative pure substances for representing characteristics of the mixture and representative ratios thereof using the determination module is performed by:
1) designating a minimum value of the arithmetic average (Avg_HSP[Aₘ]) of N HSP-Diff values to MIN[k], and designating Aₘ that shows the minimum value to a k^{th} representative pure substance A_{R}[k] (k=1);
2) designating N−1 pure substances Aₘ other than the representative pure substance A_{R}[k] designated in 1) to FF[Aₘ]=‘NONE’;
3) designating pure substances Aₘ satisfying both FF[Am]=‘NONE’ and HSP-Diff(A_{R}[k],Aₘ)<σ[k] for the representative pure substances A_{R}[k] to members of SET{A_{R}[k],L[k]} (wherein L[k] is a natural number of 1 to N_{R}[k], N_{R}[k] is a total number of pure substances Aₘ as the members of SET{A_{R}[k],L[k]} for the k^{th} representative pure substance A_{R}[k], and σ[k] is a real number of 1.0˜8.5);
4) calculating a sum (Ratio[A_{R}[k]]) of the composition ratio (R[A_{R}[k]]) of A_{R}[k] and the composition ratio (R[Aₘ]) of the pure substances Aₘ as the members of SET{A_{R}[k],L[k]};
5) calculating a total number (N_{T}) of pure substances Aₘ as members of SET{A_{R}[k],L[k]} for N_{RP} representative pure substances A_{R}[k] using Equation 3 below:
$${N}_{T} = {\sum }_{k = 1}^{{N}_{RP}} {N}_{R} [ k ] ; \qquad [ Equation 3 ]$$
6) calculating RR corresponding to a ratio of a number of pure substances reduced by the N_{RP} representative pure substances A_{R}[k] relative to a total number of pure substances of the mixture using Equation 4 below (wherein RR is a real number of 0.0˜1.0):
$$RR = \frac{{N}_{T} + {N}_{RP}}{N} ; \qquad [ Equation 4 ]$$
7) calculating a sum (TOT-R) of representative ratios of the N_{RP} representative pure substances A_{R}[k] using Equation 5 below (wherein TOT-R is a real number of 0.0˜1.0):
$$TOT \text{-} R = {\sum }_{k = 1}^{{N}_{RP}} Ratio [ {A}_{R} [ k ] ] ; \qquad [ Equation 5 ]$$
and
8) terminating a representative pure substance selection process when the RR and TOT-R values satisfy RR≧0.65˜0.90 or TOT-R≧0.70˜0.95 (convergence criteria) in which the representative pure substances exhibit characteristics of the mixture, whereas when the RR and TOT-R values do not satisfy RR≧0.65˜0.90 or TOT-R≧0.70˜0.95 (convergence criteria), designating a minimum value of the arithmetic average (Avg_HSP[Aₘ]) of HSP-Diff values of remaining pure substances other than the pure substances designated as the members of SET{A_{R}[k],L[k]} to MIN[k+1], and designating Aₘ that shows the minimum value to a k+1^{th} representative pure substance A_{R}[k+1], thus identifying characteristics of the mixture comprising N pure substances by the N_{RP} representative pure substances (A_{R}[k]) and the representative ratios (Ratio[A_{R}[k]]) thereof.

16. The system of claim 15, wherein when 3) to 8) are repeated 500˜1000 times until the convergence criteria of RR and TOT-R are satisfied, the representative pure substance selection process is terminated upon determining that no pure substance remains, or when the convergence criteria of RR and TOT-R are not satisfied after repeating 3) to 8) 500˜1000 times, the representative pure substance selection process is terminated upon determining that no representative pure substance can be selected.
